(19) United States
(12) Patent Application Publication
(10) Pub. No.: US 2026/0204213 A1
(43) Pub. Date: Jul. 16, 2026

(54) CONTROL DEVICE AND DISPLAY DEVICE

(71) Applicant: SHARP KABUSHIKI KAISHA, Sakai City, Osaka (JP)

(72) Inventors: MASAAKI MORIYA, Sakai City, Osaka (JP); Masafumi KAWAI, Sakai City, Osaka (JP); MASAFUMI UENO, Sakai City, Osaka (JP); NAOKI SHIOBARA, Sakai City, Osaka (JP); Mohammad Reza KAZEMI, Sakai City, Osaka (JP)

(21) Appl. No.: 18/866,169

(22) PCT Filed: Jul. 11, 2022
(86) PCT No.: PCT/JP2022/027187

§ 371 Date: Nov. 15, 2024

(51) Int. Cl. G09G 3/3233; G09G 3/20

(52) U.S. Cl. CPC G09G 3/3233; G09G 3/2074; G09G 2300/0443; G09G 2300/0804; G09G 2300/0819; G09G 2300/0842; G09G 2300/0861; G09G 2320/043; G09G 2320/0693; G09G 2330/10

(57) ABSTRACT

A characteristic measurement unit configured, for a pixel circuit including a light-emitting element, a drive transistor configured to control a current flowing through the light-emitting element, and a measurement transistor, to control the measurement transistor and to measure a characteristic value indicating a characteristic of at least one element selected from the group consisting of the light-emitting element and the drive transistor, a defect determination unit configured to determine that the pixel circuit is a defective pixel when the characteristic value satisfies a defective pixel condition, and a compensation unit configured to reduce a current flowing through the light-emitting element when the pixel circuit is determined as the defective pixel compared to a current flowing through the light-emitting element when the pixel circuit is not determined as the defective pixel are provided.

### TECHNICAL FIELD

The disclosure relates to a control device and a display device.

### Background Art

PTL 1 discloses a method for manufacturing an organic EL display including preparing an organic EL element having a layered structure in which a substrate, a first electrode, an organic layer including a light-emitting layer, and a second electrode are layered in this order and having a bright point defect portion in the layered structure, irradiating a predetermined layer in the organic layer corresponding to the bright point defect portion included in the organic EL element with laser light, causing multiple photon absorption to occur, and forming a non-light-emitting portion constituted by a defect portion.

### CITATION LIST

### Patent Literature

PTL 1: JP 2008-235178 A

### SUMMARY

### Technical Problem

Since the technique disclosed in PTL 1 requires a device that emits laser light, the technique disclosed in PTL 1 cannot suppress a decrease in display quality when characteristics of a pixel circuit included in a display device change over time in a situation where a laser device cannot be used. In view of the above, an object of one aspect of the disclosure is to provide a control device and a display device capable of suppressing deterioration in display quality due to a change in characteristics of a pixel circuit.

### Solution to Problem

According to one aspect of the disclosure, there is provided a control device including a characteristic measurement unit configured, for a pixel circuit including a light-emitting element, a drive transistor configured to control a current flowing through the light-emitting element, and a measurement transistor, to control the measurement transistor and to measure a characteristic value indicating a characteristic of at least one element selected from the group consisting of the light-emitting element and the drive transistor, a defect determination unit configured to determine that the pixel circuit is a defective pixel when the characteristic value satisfies a defective pixel condition, and a compensation unit configured to reduce a current flowing through the light-emitting element when the pixel circuit is determined as the defective pixel compared to a current flowing through the light-emitting element when the pixel circuit is not determined as the defective pixel.

According to one aspect of the disclosure, there is provided a control device including a characteristic measurement unit configured, for a pixel circuit including a light-emitting element, a drive transistor configured to control a current flowing through the light-emitting element, and a measurement transistor, to control the measurement transistor and to measure a characteristic value indicating a characteristic of at least one element selected from the group consisting of the light-emitting element and the drive transistor, and a compensation unit configured to reduce a current flowing through the light-emitting element in a case where a current value of a current flowing through the at least one element is equal to or smaller than a predetermined current value when the characteristic measurement unit applies a voltage having a predetermined voltage value to the at least one element.

According to one aspect of the disclosure, there is provided a control device including a characteristic measurement unit configured, for a pixel circuit including a light-emitting element, a drive transistor configured to control a current flowing through the light-emitting element, and a measurement transistor, to control the measurement transistor and to measure a characteristic value indicating a characteristic of at least one element selected from the group consisting of the light-emitting element and the drive transistor, and a compensation unit configured to reduce a current flowing through the light-emitting element when a voltage value of a voltage required for causing a current having a predetermined current value to flow through the at least one element by the characteristic measurement unit is equal to or larger than a predetermined voltage value.

According to one aspect of the disclosure, there is provided a display device including a plurality of pixel circuits and a control device, wherein each of the pixel circuits includes a light-emitting element, a drive transistor configured to control a current flowing through the light-emitting element, and a measurement transistor, and the control device includes a characteristic measurement unit configured, for each of the plurality of pixel circuits, to control the measurement transistor and to measure a characteristic value indicating a characteristic of at least one element selected from the group consisting of the light-emitting element and the drive transistor, a defect determination unit configured to determine, for each of the plurality of pixel circuits, that the pixel circuit is a defective pixel when the characteristic value satisfies a defective pixel condition, and a compensation unit configured, for each of the plurality of pixel circuits, to reduce a current flowing through the light-emitting element when the pixel circuit is determined as the defective pixel compared to a current flowing through the light-emitting element when the pixel circuit is not determined as the defective pixel.

### BRIEF DESCRIPTION OF DRAWINGS

FIG. 1 is a block diagram illustrating an example of a configuration of a display device according to a first embodiment.

FIG. 2 is a diagram illustrating an example of configurations of a display panel, a characteristic measurement unit, and a display control unit.

FIG. 3 is a diagram illustrating an example of configurations of a pixel circuit and the characteristic measurement unit.

FIG. 4 is a diagram illustrating an example of a current path when a corrected image is supplied to a pixel circuit.

FIG. 5 is a diagram illustrating an example of a current path when a characteristic value of a drive transistor is measured.

FIG. 6 is a diagram illustrating an example of a current path when a characteristic value of a light-emitting element is measured.

FIG. 7 is a graph illustrating an example of a voltage-current characteristic when a measurement transistor is normal and a voltage-current characteristic when the measurement transistor is defective.

FIG. 8 is a flowchart illustrating an example of processing of measuring characteristic values of drive transistors and determining a defective pixel in the control device according to the first embodiment.

FIG. 9 is a flowchart illustrating an example of processing of measuring characteristic values of light-emitting elements and determining a defective pixel in the control device according to the first embodiment.

FIG. 10 is a flowchart illustrating an example of processing of determining a correction value in the control device according to the first embodiment.

FIG. 11 is a flowchart illustrating an example of processing of correcting an input image.

FIG. 12 is a diagram illustrating an example of a pixel structure in which R, G, and B are disposed in this order in the X direction.

FIG. 13 is a graph illustrating an example of characteristic values of the pixel circuits disposed in the pixel structure exemplified in FIG. 12.

FIG. 14 is a flowchart illustrating an example of processing of determining a correction value in a control device according to a second embodiment.

FIG. 15 illustrates an example of a characteristic value to be corrected for the pixel circuits having the pixel structure exemplified in FIG. 12 in the control device according to the second embodiment.

FIG. 16 is a flowchart illustrating an example of processing of determining a correction value in a control device according to a third embodiment.

FIG. 17 illustrates an example of a characteristic value to be corrected for the pixel circuits disposed in the pixel structure exemplified in FIG. 12 in the control device according to the third embodiment.

FIG. 18 is a block diagram illustrating an example of a configuration of a display device according to a fourth embodiment.

FIG. 19 is a flowchart illustrating an example of processing of measuring characteristic values of drive transistors and light-emitting elements and determining a defective pixel in the control device according to the fourth embodiment.

### DESCRIPTION OF EMBODIMENTS

### First Embodiment

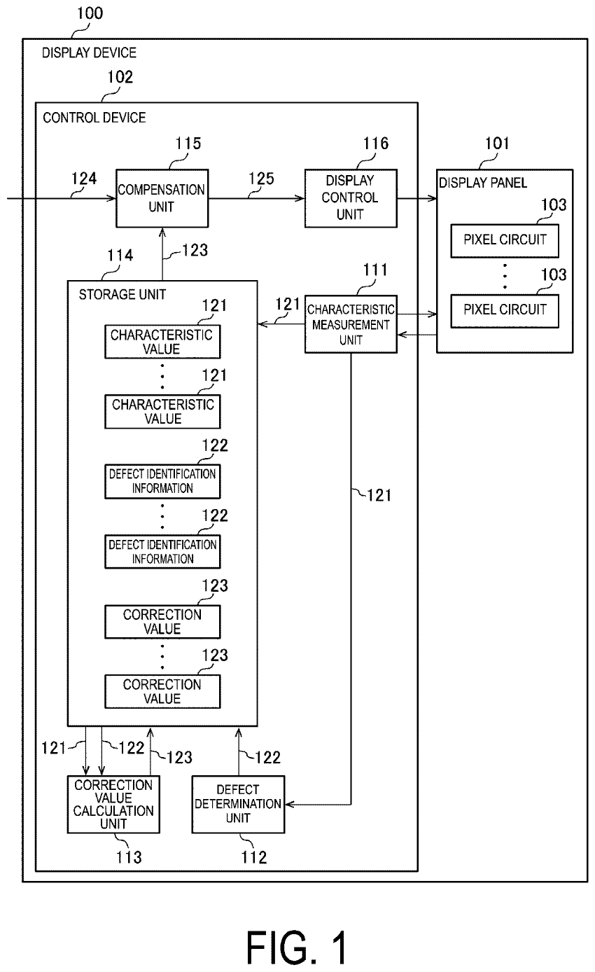

A first embodiment will be described with reference to FIG. 1 to FIG. 13. Note that, in the drawings, identical or equivalent elements are given an identical reference sign, and redundant descriptions thereof may be omitted.

FIG. 1 is a block diagram illustrating an example of a configuration of a display device 100. The display device 100 includes a display panel 101, a control device 102 and the like. The display device 100 corrects an input image according to characteristics of the display panel 101 and displays a corrected image. In the disclosure, an image refers to two-dimensional data including red (R), green (G), and blue (B) pixel data. In addition, in the disclosure, an image includes not only one piece of two dimensional data but also a plurality of pieces of two dimensional data continuous in a time direction (which may be generally referred to as a video).

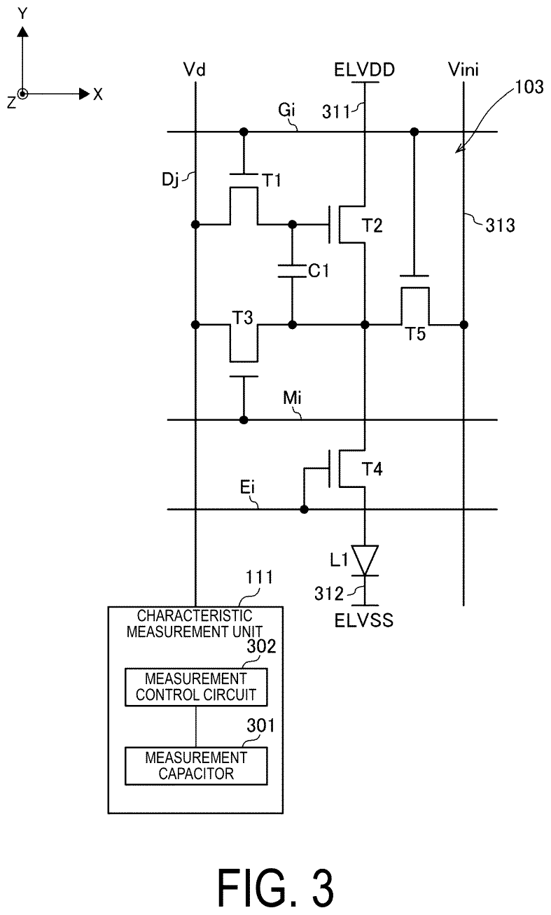

The display panel 101 includes a plurality of pixel circuits 103. Each of the pixel circuits 103 includes a light-emitting element L1 (see FIG. 3) and a plurality of transistors T1 to T5 (see FIG. 3).

The light-emitting element L1 is, for example, an Organic Light-Emitting Diode (OLED). The light-emitting element L1 may be another type of element that emits light by a current. The plurality of light-emitting elements L1 individually provided in the plurality of pixel circuits 103 include two or more types of light-emitting elements that emit light of colors different from each other.

For example, Thin Film Transistors (TFTs) are used for the transistors T1 to T5. Note that the transistor (TFT) may be a type of transistor including a channel layer made of amorphous silicon, a type of transistor including a channel layer made of low-temperature polysilicon, or a type of transistor including a channel layer made of an oxide semiconductor.

For example, the oxide semiconductor may be Indium Gallium Zinc Oxide (IGZO).

Additionally, the transistor may be a top gate type or a bottom gate type. Further, an N-channel transistor or a P-channel transistor may be used as the transistor. An example in which an N-channel transistor is used will be described below. Note that in the case of using a P-channel transistor, the levels (logics) of a signal and voltage are inverted.

The control device 102 controls the plurality of pixel circuits 103 with each of the plurality of pixel circuits 103 as a pixel circuit 103 to be compensated. The control device 102 includes a characteristic measurement unit 111, a defect determination unit 112, a correction value calculation unit 113, a storage unit 114, a compensation unit 115, a display control unit 116, and the like.

The characteristic measurement unit 111 controls the measurement transistor T3 for one pixel circuit 103 provided in the display panel 101 to measure a characteristic value 121 indicating a characteristic of at least one element selected from the group consisting of the light-emitting element L1 and the drive transistor T2. For example, the characteristic measurement unit 111 measures a voltage-current characteristic of the one element and measures the characteristic value 121 indicating a measured voltage value or current value.

When the characteristic value 121 satisfies a defective pixel condition for the pixel circuit 103, the defect determination unit 112 determines that the pixel circuit 103 is a defective pixel.

The correction value calculation unit 113 determines a correction value 123 based on the characteristic value 121. The correction value 123 is a value applied to a luminance indicated by an input image 124. Here, the input image 124 indicates luminances of the respective pixel circuits 103. To be specific, the input image 124 indicates luminances of the light-emitting elements L1 included in the respective pixel circuits 103. In the input image 124, the luminance of each pixel circuit 103 may be indicated as a gray scale value. To be more specific, when the pixel circuit 103 is not determined as a defective pixel, the correction value calculation unit 113 determines the correction value 123 such that luminances of the light-emitting elements L1 are the same for an identical gray scale value before and after a change over time of the element included in the pixel circuit. On the other hand, when the pixel circuit 103 is determined as a defective pixel, the correction value calculation unit 113 determines the correction value 123 such that the luminance of the light-emitting element L1 included in the pixel circuit 103 becomes zero.

The storage unit 114 is a storage medium that stores data in a non-volatile manner. For example, the storage unit 114 is a flash Read Only Memory (ROM). The storage unit 114 stores the characteristic value 121, defect identification information 122, and the correction value 123. The defect identification information 122 is a pixel number of the pixel circuit 103 determined as a defective pixel. The pixel number is a number for identifying the pixel circuit 103. For example, the pixel number may be a combination of a row number and a column number of the pixel circuit 103.

The compensation unit 115 acquires the input image 124 from data received from a source device. The compensation unit 115 generates a corrected image 125 by correcting the input image 124 based on the characteristic value 121 measured for each pixel circuit 103 among the plurality of pixel circuits 103. Specifically, the compensation unit 115 generates the corrected image 125 by correcting the input image 124 based on the correction value 123.

For example, it is assumed that the characteristic value 121 indicates a current value of a current flowing through at least one element selected from the group consisting of the light-emitting element L1 and the drive transistor T2 when a voltage of a predetermined voltage value is applied to the at least one element. In this case, the compensation unit 115 generates the corrected image 125 by correcting the input image 124 based on the correction value 123 such that the luminance of the pixel circuit 103 becomes higher than the luminance of the pixel circuit 103 indicated by the input image 124 as the current value indicated by the characteristic value 121 of the pixel circuit 103 is relatively lower.

In addition, for example, it is assumed that the characteristic value 121 indicates a voltage value of a voltage necessary to cause a current of a predetermined current value to flow through at least one element selected from the group consisting of the light-emitting element L1 and the drive transistor T2. In this case, the compensation unit 115 generates the corrected image 125 by correcting the input image 124 based on the correction value 123 such that the luminance of the pixel circuit 103 becomes higher than the luminance of the pixel circuit 103 indicated by the input image 124 as the voltage value indicated by the characteristic value 121 of the pixel circuit 103 is relatively higher.

Furthermore, the compensation unit 115 reduces a current flowing through the light-emitting element L1 when the pixel circuit 103 is determined as a defective pixel, compared to a current flowing through the light-emitting element L1 when the pixel circuit 103 is not determined as a defective pixel. To be specific, when the pixel circuit 103 is determined as a defective pixel, the compensation unit 115 does not cause a current to flow through the light-emitting element L1. That is, when the pixel circuit 103 is determined as a defective pixel, the compensation unit 115 corrects the input image 124 such that the light-emitting element L1 does not emit light.

The display control unit 116 causes a scanning line drive circuit 202 and a data line drive circuit 203, which will be described later, to supply voltages corresponding to the corrected image 125 to the plurality of pixel circuits 103 and thus to drive the plurality of pixel circuits 103. Specifically, the display control unit 116 applies a voltage having a voltage value corresponding to the luminance of each of the pixel circuits 103 indicated by the corrected image 125 to the corresponding pixel circuit 103, and thus drives each of the pixel circuits 103.

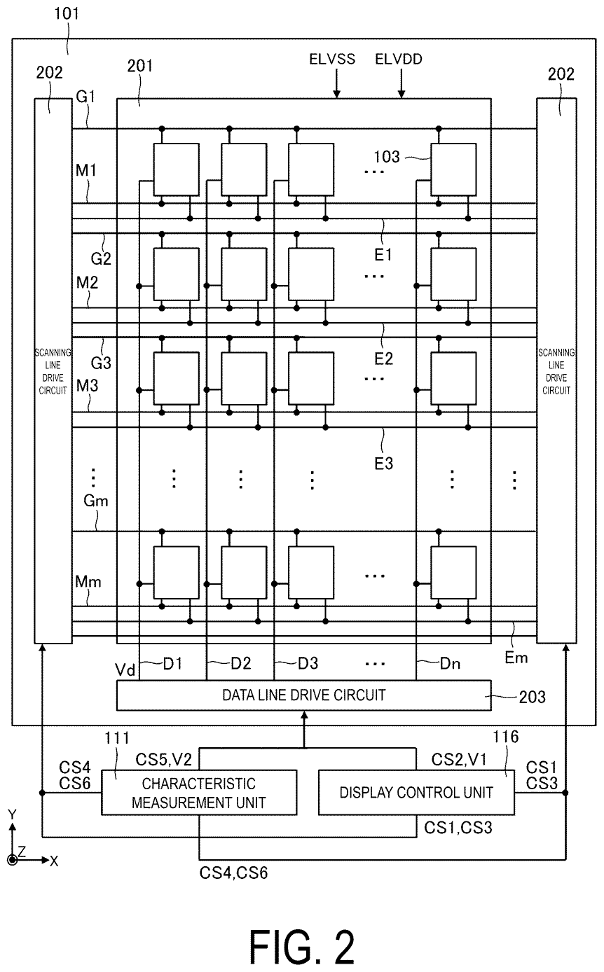

Next, an example of the display panel 101 will be described with reference to FIG. 2. FIG. 2 is a diagram illustrating an example of a configuration of the display panel 101. In the following description, a horizontal direction of FIG. 2 is referred to as an X direction. Further, a vertical direction of FIG. 2 is referred to as a Y direction. The X direction is one of a long-side direction or a short-side direction on a plane of the display panel 101, and the Y direction is the other of the long-side direction or the short-side direction. The X direction and the Y direction are orthogonal to each other. Further, the X direction and the Y direction are perpendicular to a Z direction that is a thickness direction of the display panel 101. Here, each of m and n is an integer of 2 or more. In addition, i, which will be used in the following description, is an integer of 1 or more and m or less. Further, j, which will be used in the following description, is an integer of 1 or more and n or less. Furthermore, an on level means a voltage level at which a transistor is turned on when a voltage is applied to the gate terminal. Moreover, an off level means a voltage level at which the transistor is turned off when a voltage is applied to the gate terminal. For example, in a case of an N-channel transistor, the on level is a high level, and the off level is a low level.

As exemplified in FIG. 2, the display panel 101 includes a display unit 201, the scanning line drive circuit 202, and the data line drive circuit 203. The scanning line drive circuit 202 and the data line drive circuit 203 are connected to the display control unit 116 and the characteristic measurement unit 111. In addition, each of the plurality of pixel circuits 103 is constantly supplied with a high-level power supply voltage ELVDD, and a low-level power supply voltage ELVSS by using a wiring line and an electrode that are electrically conductive members not illustrated.

The display unit 201 includes m scanning lines G1 to Gm, m measurement control lines M1 to Mm, m light emission control lines E1 to Em, and n data lines D1 to Dn. Further, m×n pixel circuits 103 are aligned on a plane (one surface) of the display unit 201. The scanning lines G1 to Gm, the measurement control lines M1 to Mm, and the light emission control lines El to Em extend in the X direction and are parallel to each other. The data lines D1 to Dn extend in the Y direction and are parallel to each other. The scanning lines G1 to Gm, the measurement control lines M1 to Mm, and the light emission control lines El to Em are orthogonal to the data lines D1 to Dn. The scanning lines G1 to Gm and the data lines D1 to Dn intersect with each other at (m×n) positions. The pixel circuit 103 at an i-th row and a j-th column is connected to the scanning line Gi, the measurement control line Mj, the light emission control line Ei, and the data line Dj.

The display control unit 116 outputs a control signal CS2 and a data voltage Vd of a voltage value V1 to the data line drive circuit 203. Further, when the corrected image 125 is supplied, the display control unit 116 outputs control signals CS1 and CS3 to the scanning line drive circuit 202. The scanning line drive circuit 202 controls levels of the scanning lines G1 to Gm based on the control signal CS1. Additionally, the scanning line drive circuit 202 controls levels of the measurement control lines M1 to Mm and the light emission control lines E1 to Em based on the control signal CS3.

The data line drive circuit 203 applies the data voltage Vd to the data lines D1 to Dn instructed by the control signal CS2. The characteristic measurement unit 111 and the display control unit 116 control operations of the scanning line drive circuit 202 and the data line drive circuit 203.

In measuring the characteristic value 121, the characteristic measurement unit 111 outputs measurement control signals CS4 and CS6 to the scanning line drive circuit 202. The measurement control signal CS4 indicates the scanning line G connected to the pixel circuit 103 to be measured. The measurement control signal CS6 indicates the measurement control line M and the light emission control line E that are connected to the pixel circuit 103 to be measured.

Further, the characteristic measurement unit 111 outputs a measurement control signal CS5 and a voltage of a measurement voltage value V2 to the data line drive circuit 203.

Magnitude of the measurement voltage value V2 is determined in advance. The data line drive circuit 203 applies the voltage of the instructed measurement voltage value V2 to the data line D instructed by the measurement control signal CS5.

Based on the measurement control signal CS4, the scanning line drive circuit 202 sets the level of the scanning line connected to the pixel circuit 103 to be measured among the scanning lines G1 to Gm to the on level. In addition, the scanning line drive circuit 202 controls the levels of the measurement control line M and the light emission control line E that are connected to the pixel circuit 103 to be measured based on the measurement control signal CS6.

Next, an example of the pixel circuit 103 and the characteristic measurement unit 111 will be described with reference to FIG. 3. FIG. 3 is diagram illustrating an example of a configuration of the pixel circuit 103 and the characteristic measurement unit 111. In FIG. 3, for convenience of explanation, the data line drive circuit 203 is omitted, and the example of the configuration of the pixel circuit 103 and the characteristic measurement unit 111 is illustrated. The respective pixel circuits 103 have the same configuration. In the following description, the pixel circuit 103 at the i-th row and the j-th column will be exemplified and described. The pixel circuit 103 includes the write control transistor T1, the drive transistor T2, the measurement transistor T3, the light emission control transistor T4, the initialization transistor T5, the light-emitting element L1, and a capacitor C1. Each transistor is, for example, an N-channel thin film transistor.

Additionally, a first power supply line 311, a second power supply line 312, and a third power supply line 313 are connected to the pixel circuit 103. The first power supply line 311, the second power supply line 312, and the third power supply line 313 are connected to a power supply circuit (not illustrated). The first power supply line 311 is applied with the high-level power supply voltage ELVDD. The second power supply line 312 is applied with the low-level power supply voltage EL VSS. The third power supply line 313 is applied with an initial voltage Vini. Additionally, the pixel circuit 103 is connected with the scanning line Gi, a measurement control line Mi, the light emission control line Ei, and the data line Dj. The data line Dj is a line for applying a voltage to a gate of the drive transistor T2.

A gate of the write control transistor T1 is connected to the scanning line Gi. A drain of the write control transistor T1 is connected to the data line Dj. A source of the write control transistor T1 is connected to a terminal on one side of the capacitor C1, and a gate of the drive transistor T2. When the write control transistor T1 is in an on state, the write control transistor T1 connects the data line Dj and the gate of the drive transistor T2.

A drain of the drive transistor T2 is connected to the power supply line 311. A source of the drive transistor T2 is connected to a terminal on the other side of the capacitor C1, the measurement transistor T3, the light emission control transistor T4, and the initialization transistor T5.

The measurement transistor T3 is constituted by a thin film transistor. A current can bidirectionally flow through the thin film transistor constituting the measurement transistor T3. A gate of the measurement transistor T3 is connected to the measurement control line Mi.

Additionally, one of the terminals other than the gate of the measurement transistor T3 is connected to the data line Dj. In addition, the other of the terminals other than the gate of the measurement transistor T3 is connected to the capacitor C1, the drive transistor T2, the light emission control transistor T4, and the initialization transistor T5.

The measurement transistor T3 is switched between an on state and an off state based on a level of the measurement control line Mi. When the measurement transistor T3 is in the on state, the data line Dj is connected to the capacitor C1, the drive transistor T2, the light emission control transistor T4, and the initialization transistor T5.

The light emission control transistor T4 switches between supply and stop of a current to the light-emitting element L1. That is, the light emission control transistor T4 controls light emission of the light-emitting element L1. A gate of the light emission control transistor T4 is connected to the light emission control line Ei. An anode of the light-emitting element L1 is connected to the light emission control transistor T4. A cathode of the light-emitting element L1 is connected to the second power supply line.

A gate of the initialization transistor T5 is connected to the scanning line Gi. One of the terminals other than the gate of the initialization transistor T5 is connected to the third power supply line 313. The other of the terminals other than the gate of the initialization transistor T5 is connected to the capacitor C1, the drive transistor T2, the measurement transistor T3, and the light emission control transistor T4.

The characteristic measurement unit 111 controls the measurement transistor T3 such that a current flows through the element whose characteristic is to be measured. The characteristic measurement unit 111 includes a measurement capacitor 301, a measurement control circuit 302, and the like. The measurement capacitor 301 stores electric charges of a current flowing for a predetermined time. A voltage between terminals of the measurement capacitor 301 changes according to an amount of the charged electric charges. The measurement control circuit 302 recognizes the voltage between the terminals of the measurement capacitor 301 and measures an amount of the current flowing for the predetermined time as the characteristic value 121.

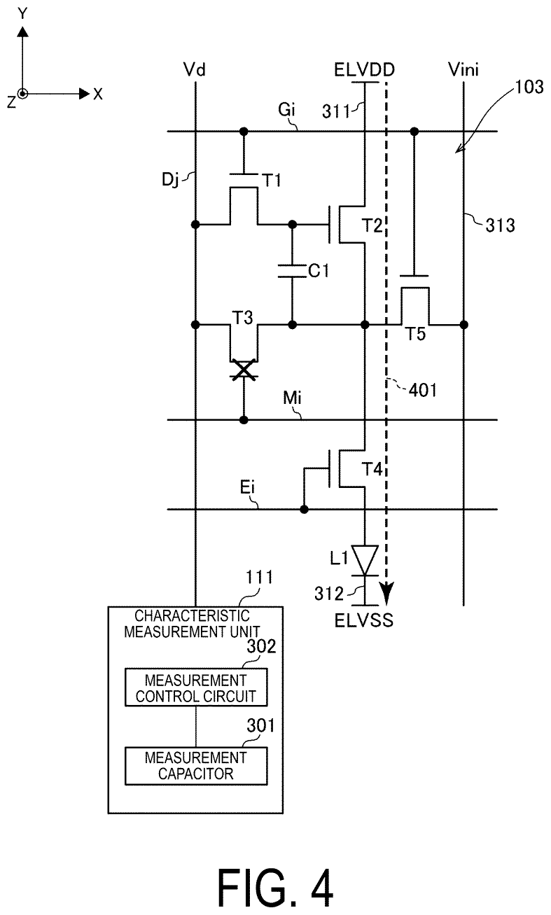

Next, an operation when the corrected image 125 is supplied to each pixel circuit 103 will be described with reference to FIG. 4. The display control unit 116 causes the scanning line drive circuit 202 to switch the scanning line Gi to be set to the on level for each horizontal scan period. The scanning lines G1 to Gm are sequentially and exclusively set to the on level. Note that the display control unit 116 maintains the measurement control line Mi at the off level, thereby allowing the measurement transistor T3 to be maintained in the off state.

When the scanning line Gi is at the on level, the write control transistor T1 provided in each pixel circuit 103 positioned in the i-th row is in the on state. Thus, a gate potential of the drive transistor T2 becomes close to the data voltage Vd applied to the data line Dj. This turns the drive transistor T2 into the on state. Additionally, when an image is displayed, the display control unit 116 turns on the light emission control transistor T4 provided in each pixel circuit 103. For example, the display control unit 116 instructs the scanning line drive circuit 202 to set the levels of the light emission control lines E1 to Em to the on level. As a result, a current flows toward the light-emitting element L1 through a current path 401 exemplified in FIG. 4, and the light-emitting element L1 emits light at a luminance corresponding to the voltage value V1 of the data voltage Vd.

When a select period of the scanning line Gi ends, the scanning line drive circuit 202 changes the scanning line Gi to the off level. This changes the write control transistor T1 into the off state in the pixel circuit 103. In the pixel circuit 103, even when the write control transistor T1 is turned off, the capacitor C1 holds a gate-source voltage of the drive transistor T2. For this reason, until the scanning line Gi becomes at the on level again, the drive transistor T2 continues to supply the current corresponding to the voltage held by the capacitor C1 to the light-emitting element L1. As a result, the light-emitting element L1 continues to emit light until the scanning line Gi becomes at the on level again.

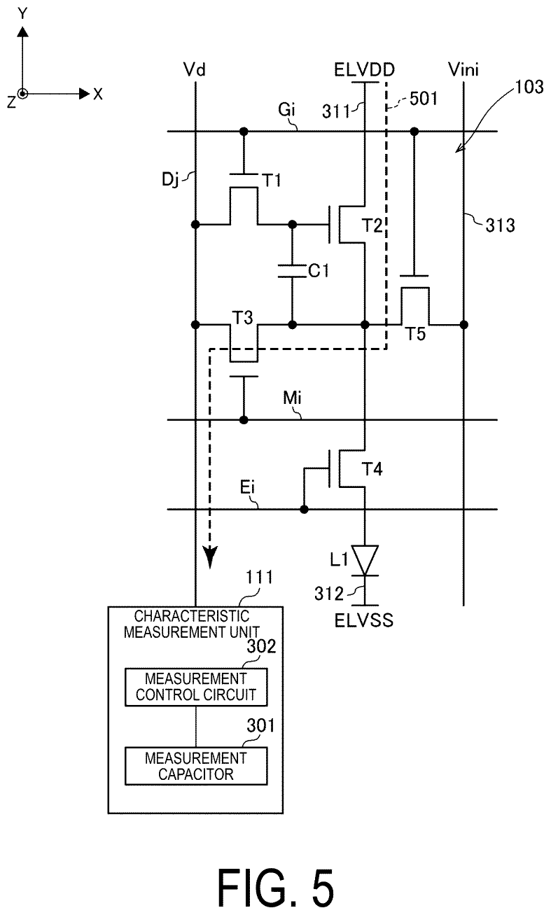

Next, a case where the characteristic measurement unit 111 measures the characteristic value 121 of the drive transistor T2 will be described with reference to FIG. 5.

The characteristic measurement unit 111 instructs the data line drive circuit 203 to apply a voltage of the measurement voltage value V2 to the data line Dj of the pixel circuit 103 to be measured. Subsequently, the characteristic measurement unit 111 instructs the scanning line drive circuit 202 to change the level of the scanning line Gi of the pixel circuit 103 to be measured to the on level. Thus, the write control transistor T1 of the pixel circuit 103 to be measured is turned on. As a result, the voltage of the measurement voltage value V2 is applied to the capacitor C1. The voltage at one of the terminals of the capacitor C1 rises, and the drive transistor T2 is turned on. Until this stage, the characteristic measurement unit 111 instructs the scanning line drive circuit 202 to maintain the measurement transistor T3 included in the pixel circuit 103 to be measured in the off state. In addition, the characteristic measurement unit 111 instructs the scanning line drive circuit 202 to maintain the light emission control line Ei of the pixel circuit 103 to be measured at the off level. This maintains the light emission control transistor T4 in the off state.

When the drive transistor T2 is turned on, a current corresponding to electric charges accumulated in the capacitor C1 starts to flow. When the application of the voltage of the measurement voltage value V2 to the data line Dj of the pixel circuit 103 to be measured is stopped, the characteristic measurement unit 111 instructs the scanning line drive circuit 202 to make the measurement transistor T3 included in the pixel circuit 103 to be measured conductive. As a result, a current flows toward the characteristic measurement unit 111 through the first power supply line 311, the drive transistor T2, the measurement transistor T3, and the data line Dj. That is, the current flows toward the characteristic measurement unit 111 through a current path 501 illustrated in FIG. 5, and the current does not flow into the light-emitting element L1.

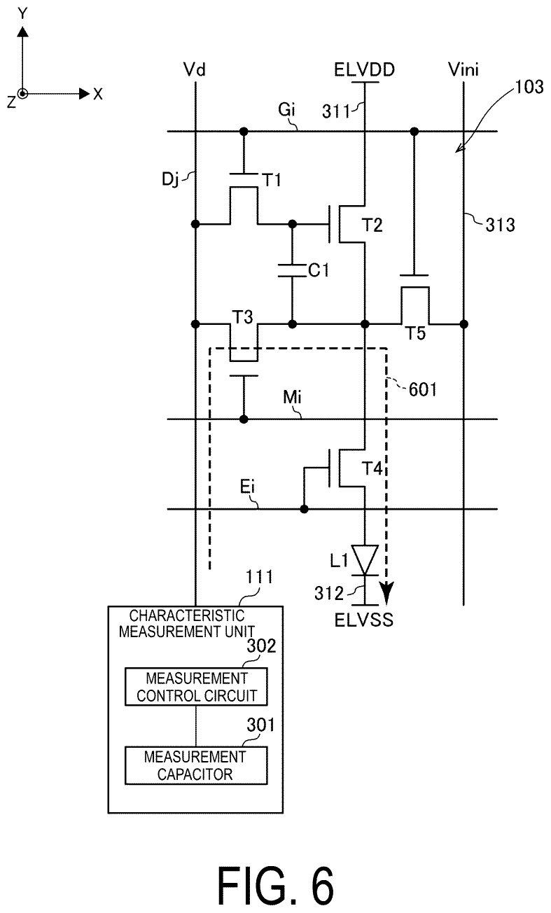

Next, with reference to FIG. 6, a description will be given of a case where the characteristic measurement unit 111 measures the characteristic value 121 of the light-emitting element L1.

The characteristic measurement unit 111 instructs the data line drive circuit 203 to apply a voltage for turning off the drive transistor T2 to the data line Dj of the pixel circuit 103 to be measured. Subsequently, the characteristic measurement unit 111 instructs the scanning line drive circuit 202 to change the level of the scanning line Gi of the pixel circuit 103 to be measured to the on level. Thus, the write control transistor T1 of the pixel circuit 103 to be measured is turned on. As a result, a voltage at which the drive transistor T2 is turned off is applied to the capacitor C1.

The voltage of one of the terminals of the capacitor C1 becomes the voltage at which the drive transistor T2 is turned off, and thus, the drive transistor T2 is turned off.

The characteristic measurement unit 111 instructs the scanning line drive circuit 202 to change the scanning line Gi of the pixel circuit 103 to be measured to the off level. This causes the write control transistor T1 to be set to the off state, and maintains the drive transistor T2 in the on state.

On the other hand, the characteristic measurement unit 111 instructs the data line drive circuit 203 to apply the voltage of the measurement voltage value V2 to the data line Dj of the pixel circuit 103 to be measured. In addition, the characteristic measurement unit 111 instructs the scanning line drive circuit 202 to make the measurement transistor T3 conductive. Further, the characteristic measurement unit 111 instructs the scanning line drive circuit 202 to maintain the light emission control line Ei of the pixel circuit 103 to be measured at the on level. This maintains the light emission control transistor T4 in the on state.

When the light emission control transistor T4 is turned on, a current flows from the capacitor C1 toward the light-emitting element L1 through the data line Dj, the measurement transistor T3, and the light emission control transistor T4. That is, a current flows toward the light-emitting element L1 through a current path 601 exemplified in FIG. 6, and a current does not flow through the drive transistor T2.

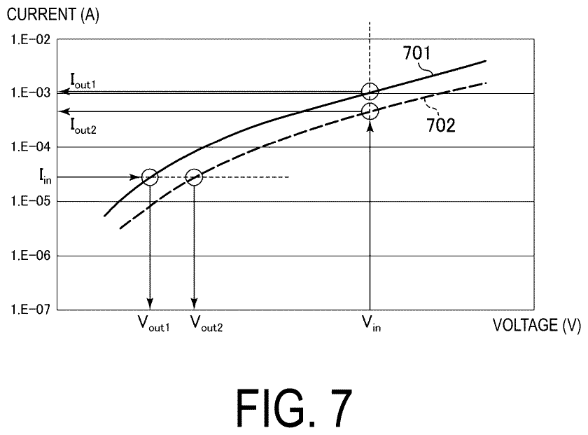

FIG. 7 illustrates a graph 701 illustrating an example of a voltage-current characteristic of the light-emitting element L1 when the measurement transistor T3 is normal, and a graph 702 illustrating an example of a voltage-current characteristic obtained by measurement when the measurement transistor T3 is defective. In FIG. 7, the horizontal axis represents a voltage, and the vertical axis represents a current.

As illustrated in the graph 701, when the measurement transistor T3 is normal and a voltage of a measurement voltage value Vᵢₙ is applied to the data line D, a value of a current flowing through the light-emitting element L1 is Iₒᵤₜ₁. On the other hand, in the case where the measurement transistor T3 is defective, when the measurement transistor T3 is in the on state, a drain-source resistance becomes higher than that in the case where the measurement transistor T3 is normal. Thus, as exemplified in the graph 702, when the measurement transistor T3 is defective and the voltage of the measurement voltage value Vᵢₙ is applied to the data line Dj, the current value of the current flowing through the light-emitting element L1 may be Iₒᵤₜ₂ lower than Iₒᵤₜ₁. In this case, although the measurement result should be obtained as illustrated in the graph 701, the measurement result deteriorated as illustrated in the graph 702 due to a defect of the measurement transistor T3 may be erroneously obtained.

Similarly, as illustrated in the graph 701, when the measurement transistor T3 is normal, the voltage required to cause the current of the measurement current value Iᵢₙ to flow through the data line D is Vₒᵤₜ₁. On the other hand, in the case where the measurement transistor T3 is defective, when the measurement transistor T3 is in the on state, the drain-source resistance becomes higher than that in the case where the measurement transistor T3 is normal. Thus, as illustrated in the graph 702, when the measurement transistor T3 is defective, the voltage required to cause the current of the measurement current amount Iᵢₙ to flow through the data line D may become Vₒᵤₜ₂ higher than Vₒᵤₜ₁ due to the voltage drop caused by the drain-source resistance of the measurement transistor T3. Therefore, although the measurement result should be obtained as illustrated in the graph 701, the measurement result deteriorated as illustrated in the graph 702 due to a defect of the measurement transistor T3 may be erroneously obtained.

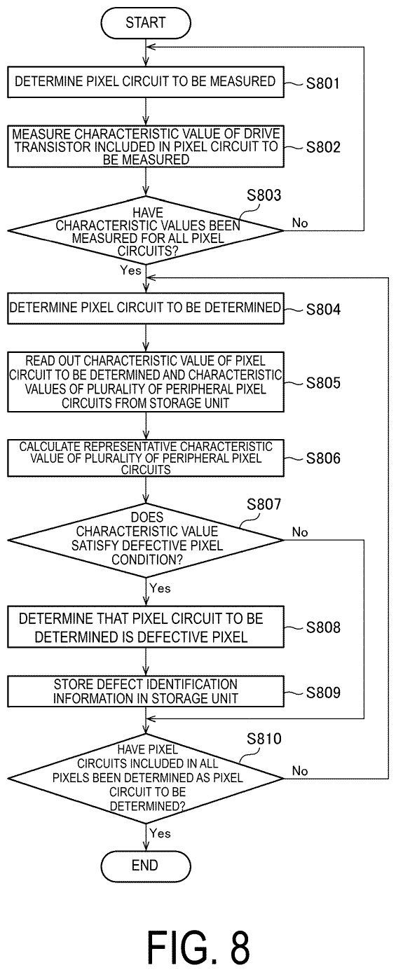

FIG. 8 is a flowchart illustrating an example of processing of determining a defective pixel by measuring the characteristic value 121 of the drive transistor T2 in the control device 102 according to the present embodiment.

In step S801, the characteristic measurement unit 111 determines the pixel circuit 103 to be measured from the plurality of pixel circuits 103. To be more specific, the data line drive circuit 203 is instructed to apply the voltage of the measurement voltage value V2 to the data line Dj of the pixel circuit 103 to be measured.

In step S802, the characteristic measurement unit 111 measures the characteristic value 121 of the drive transistor T2 included in the pixel circuit 103 to be measured, which has been determined in step S801, and stores the measured characteristic value 121 in the storage unit 114. For example, the characteristic measurement unit 111 stores, in the storage unit 114, the pixel number of the pixel circuit 103 and the measured characteristic value 121 in association with each other. Specifically, the characteristic measurement unit 111 causes a current to flow toward the characteristic measurement unit 111 through the current path 501 illustrated in FIG. 5. Then, the measurement control circuit 302 recognizes a voltage between the terminals of the measurement capacitor 301 and measures an amount of a current flowing for a predetermined time as the characteristic value 121.

In step S803, the characteristic measurement unit 111 determines whether or not the characteristic values 121 have been measured for all the pixel circuits 103. In a case where the characteristic values 121 have been measured for all the pixel circuits 103 in step S803, the control device 102 shifts the processing to step S804. On the other hand, in a case where the characteristic values 121 have not been measured for all the pixel circuits 103 in step S803, the control device 102 returns the processing to step S801. That is, the control device 102 repeats the processing of steps S801 to S803 until the characteristic values 121 are measured for all the pixel circuits 103.

In step S804, the defect determination unit 112 specifies the pixel circuit 103 to be determined from the plurality of pixel circuits 103. For example, the defect determination unit 112 specifies a pixel number for identifying the pixel circuit 103 to be determined.

In step S805, the defect determination unit 112 reads the characteristic value 121 of the pixel circuit 103 to be determined and the characteristic values 121 of a plurality of peripheral pixel circuits from the storage unit 114. The plurality of peripheral pixel circuits are a plurality of pixel circuits 103 different from the pixel circuit 103 to be determined. For example, each peripheral pixel circuit among the plurality of peripheral pixel circuits is disposed at a position adjacent to the pixel circuit 103 to be determined. When the plurality of pixel circuits 103 are disposed in a matrix, the adjacent position means positions in a right-left direction, an up-down direction, and diagonal directions of the pixel circuit 103. Further, the light-emitting element L1 included in the pixel circuit 103 and the plurality of light-emitting element L1 individually included in the plurality of peripheral pixel circuits emit light of the same color.

In step S806, the defect determination unit 112 calculates a representative characteristic value of the plurality of peripheral pixel circuits for the pixel circuit 103 to be determined. For example, it is assumed that when a voltage of a predetermined voltage value is applied to at least one element selected from the group consisting of the light-emitting element L1 and the drive transistor T2 by controlling the measurement transistor T3, the characteristic value 121 indicates a current value of a current flowing through the at least one element. In this case, the representative characteristic value is a representative current value of the plurality of current values individually measured for the plurality of peripheral pixel circuits. For example, the representative characteristic value is a representative value such as an average value of the plurality of current values individually measured for the plurality of peripheral pixel circuits.

Alternatively, for example, when a current of a predetermined current value is caused to flow through at least one element selected from the group consisting of the light-emitting element L1 and the drive transistor T2 by controlling the measurement transistor T3, the characteristic value 121 indicates a voltage value of a voltage applied to the at least one element. In this case, the representative characteristic value is a representative voltage value of the plurality of voltage values individually measured for the plurality of peripheral pixel circuits. For example, the representative characteristic value is a representative value such as an average value of the plurality of voltage values individually measured for the plurality of peripheral pixel circuits.

In step S807, the defect determination unit 112 determines whether or not the characteristic value 121 of the pixel circuit 103 to be determined satisfies a defective pixel condition based on the representative characteristic value. For example, it is assumed that the characteristic value 121 of the pixel circuit 103 and the characteristic values of the peripheral pixel circuits indicate current values. In this case, the defective pixel condition is that the current value indicated by the characteristic value 121 for the pixel circuit 103 is lower than the representative current value by a first threshold value or more. In other words, when the current value indicated by the characteristic value 121 is lower than the representative current value by the first threshold value or more, the defect determination unit 112 determines that the characteristic value 121 of the pixel circuit 103 to be determined satisfies the defective pixel condition.

When the measurement transistor T3 is defective, in a state where the measurement transistor T3 is in the on state, the drain-source resistance becomes higher than that when the measurement transistor T3 is normal. In this case, the current flowing toward the characteristic measurement unit 111 through the current path 501 exemplified in FIG. 5 is smaller than that in the case where the measurement transistor T3 is normal. As a result, the current flowing toward the characteristic measurement unit 111 through the current path 501 is smaller than a current flowing through the same path in the peripheral pixel circuit in which the measurement transistor T3 is normal. That is, when the measurement transistor T3 is defective, the current is difficult to flow in the pixel circuit 103. Therefore, when the measurement transistor T3 is defective, the current value indicated by the characteristic value 121 of the pixel circuit 103 is lower than the representative current value of the peripheral pixel circuits.

Alternatively, for example, it is assumed that the characteristic value 121 of the pixel circuit 103 and the characteristic values 121 of the peripheral pixel circuits indicate voltage values. In this case, the defective pixel condition is that the voltage value indicated by the characteristic value 121 of the pixel circuit 103 is higher than the representative voltage value by a second threshold value or more. In other words, when the voltage value indicated by the characteristic value 121 is higher than the representative voltage value by the second threshold value or more, the defect determination unit 112 determines that the characteristic value 121 of the pixel circuit 103 to be determined satisfies the defective pixel condition.

Similar to the reason described above, when the measurement transistor T3 is defective, the drain-source resistance in the state where the measurement transistor T3 is in the on state is higher than that in the case where the measurement transistor T3 is normal. Therefore, in order to cause a current of a predetermined current value to flow toward the characteristic measurement unit 111 through the current path 501, it is necessary to apply a voltage higher than that in the case where the measurement transistor T3 is normal. As a result, the voltage applied to the drive transistor T2 is higher than the voltage applied when the measurement transistor T3 is normal.

That is, when the measurement transistor T3 is defective, the current is difficult to flow in the pixel circuit 103, and the measured voltage value is higher than the voltage applied to the drive transistor T2 in the peripheral pixel circuit 103 in which the measurement transistor T3 is normal. Therefore, when the measurement transistor T3 is a defective pixel, the voltage value indicated by the characteristic value 121 of the pixel circuit 103 is higher than the representative voltage value of the peripheral pixel circuits.

When the characteristic value 121 of the pixel circuit 103 to be determined does not satisfy the defective pixel condition in step S807, the control device 102 shifts the processing to step S810. On the other hand, when the characteristic value 121 of the pixel circuit 103 to be determined satisfies the defective pixel condition in step S807, the defect determination unit 112 determines that the pixel circuit 103 to be determined is a defective pixel in step S808.

Alternatively, when the pixel circuit 103 to be determined is the pixel circuit 103 of any one of subpixels of RGB, the defect determination unit 112 determines that all the pixel circuits 103 constituting a pixel including the one subpixel are defective pixels. Then, in step S809, the defect determination unit 112 stores the defect identification information 122 indicating the pixel number of the pixel circuit 103 to be determined in the storage unit 114.

In step S810, the defect determination unit 112 determines whether or not the pixel circuits 103 belonging to all the pixels have been determined as the pixel circuit 103 to be determined. In a case where the pixel circuits 103 belonging to all the pixels have not been determined yet as the pixel circuit 103 to be determined, the control device 102 returns the processing to step S804. That is, the control device 102 repeats the processing from step S804 to step S810 until the pixel circuits 103 belonging to all the pixels have been determined to be a defective pixel or not. On the other hand, in a case where the pixel circuits 103 belonging to all the pixels have been determined as the pixel circuit 103 to be determined, the control device 102 ends the processing of determining a defective pixel.

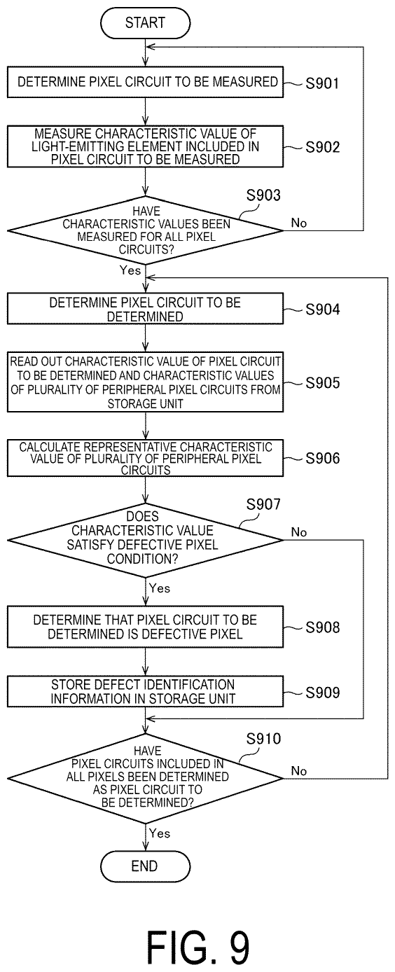

FIG. 9 is a flowchart illustrating an example of processing of determining a defective pixel by measuring the characteristic value 121 of the light-emitting element L1 in the control device 102 according to the present embodiment.

In step S901, the characteristic measurement unit 111 determines the pixel circuit 103 to be measured from the plurality of pixel circuits 103. Since step S901 is similar to step S801 exemplified in FIG. 8, a detailed description will be omitted.

In step S902, the characteristic measurement unit 111 measures the characteristic value 121 of the light-emitting element L1 included in the pixel circuit 103 to be measured, which has been determined in step S901, and stores the measured characteristic value 121 in the storage unit 114. For example, the characteristic measurement unit 111 stores, in the storage unit 114, the pixel number of the pixel circuit 103 and the measured characteristic value 121 in association with each other. To be more specific, the characteristic measurement unit 111 causes a current to flow to the light-emitting element L1 through the current path 601 exemplified in FIG. 6. Then, the measurement control circuit 302 recognizes a voltage between the terminals of the measurement capacitor 301 and measures an amount of a current flowing for a predetermined time as the characteristic value 121. In addition, the control device 102 shifts the processing to step S903. Processing from steps S903 to S910 is similar to processing of steps S803 to S810 exemplified in FIG. 8, and thus detailed descriptions thereof will be omitted.

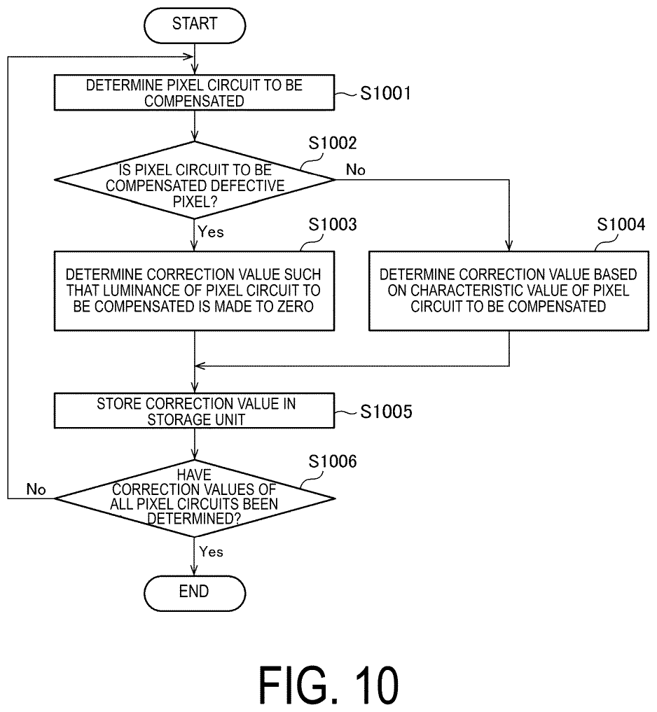

FIG. 10 is a flowchart illustrating an example of processing of determining the correction value 123 in the control device 102 according to the present embodiment. It is assumed that the defect identification information 122 and the characteristic values 121 of the plurality of pixel circuits 103 are stored in the storage unit 114 at the time when processing of step S1001 exemplified in FIG. 10 is started.

In step S1001, the correction value calculation unit 113 determines the pixel circuit 103 to be compensated from the plurality of pixel circuits 103. For example, the correction value calculation unit 113 specifies the pixel number of the pixel circuit 103 to be compensated from the plurality of pixel circuits 103.

In step S1002, the correction value calculation unit 113 determines whether or not the pixel circuit 103 to be compensated is a defective pixel. Specifically, the correction value calculation unit 113 determines whether or not the pixel number of the pixel circuit 103 to be compensated matches the pixel number indicated by the defect identification information 122 stored in the storage unit 114. When the pixel number of the pixel circuit 103 to be compensated matches the pixel number indicated by the defect identification information 122 stored in the storage unit 114, the correction value calculation unit 113 determines that the pixel circuit 103 to be compensated is a defective pixel. On the other hand, when the pixel number of the pixel circuit 103 to be compensated does not match the pixel number indicated by the defect identification information 122 stored in the storage unit 114, the correction value calculation unit 113 determines that the pixel circuit 103 to be compensated is not a defective pixel.

When it is determined that the pixel circuit 103 to be compensated is a defective pixel in step S1002, the correction value calculation unit 113 determines the correction value 123 such that a luminance of the pixel circuit 103 to be compensated is set to zero in step S1003. That is, when the pixel circuit 103 to be compensated is determined to be a defective pixel, the correction value calculation unit 113 determines the correction value 123 such that a current does not flow through the light-emitting element L1 included in the pixel circuit 103. For example, when the pixel circuit 103 to be compensated is determined as a defective pixel for any one of the subpixels of RGB, the correction value calculation unit 113 determines the correction values 123 of all the subpixels constituting the pixel including the one sub-pixel such that no current flows through the light-emitting elements L1 included in the pixel circuits 103. Then, the control device 102 shifts the processing to step S1005.

On the other hand, when it is not determined that the pixel circuit 103 to be compensated is a defective pixel in step S1002, the correction value calculation unit 113 determines the correction value 123 based on the characteristic value 121 of the pixel circuit 103 to be compensated in step S1004. For example, the correction value calculation unit 113 stores, in advance, the characteristic value 121 measured in a state before a change over time in the storage unit 114. The state before the change over time is, for example, a state immediately after the display device 100 is manufactured. Then, the correction value calculation unit 113 determines, as the correction value 123, a value of a parameter to be input to a conversion equation for converting the characteristic value 121 measured in the state after the change over time into the characteristic value 121 measured in the state before the change over time. For example, the correction value calculation unit 113 determines the correction value 123 such that as the current value indicated by the characteristic value 121 of the pixel circuit 103 to be compensated is lower than the current value indicated by the characteristic value 121 measured in the state before the change over time, the luminance of the light-emitting element L1 is made higher.

Then, in step S1005, the correction value calculation unit 113 stores the correction value 123 determined in step S1003 or step S1004 in the storage unit 114.

In step S1006, the correction value calculation unit 113 determines whether or not the correction values 123 have been determined for all the pixel circuits 103. In a case where the correction values 123 have not been determined for all the pixel circuits 103 in step S1006, the control device 102 returns the processing to step S1001. That is, the control device 102 repeats the processing from step S1001 to step S1006 until the correction values 123 have been determined for all the pixel circuits 103. On the other hand, in a case where the correction values 123 have been determined for all the pixel circuits 103 in step S1006, the control device 102 ends the processing of determining the correction values 123.

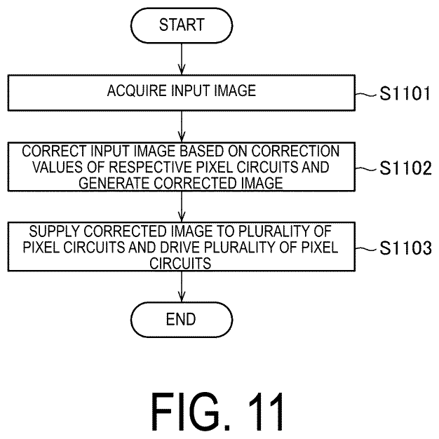

FIG. 11 is a flowchart illustrating an example of processing of correcting the input image 124. It is assumed that the correction values 123 of the plurality of pixel circuits 103 are stored in the storage unit 114 at the time of starting processing of step S1101 exemplified in FIG. 11. Note that the control device 102 may perform the processing exemplified in FIG. 8 to FIG. 10 at predetermined time intervals, and the correction values 123 may be stored in the storage unit 114 when an image is displayed on the display panel 102.

In step S1101, the compensation unit 115 acquires the input image 124. In step S1102, the compensation unit 115 generates the corrected image 125 by correcting the input image 124 based on the correction values 123 of the respective pixel circuits 103.

Here, when the measurement transistor T3 included in the pixel circuit 103 is defective, the current value indicated by the characteristic value 121 is lower than those of the characteristic values 121 of the peripheral pixel circuits. Supposing the compensation unit 115 determines the correction value 123 in step S1004 exemplified in FIG. 10 regardless of whether or not the pixel circuit 103 is a defective pixel, the compensation unit 115 may generate the corrected image 125 by correcting the input image 124 such that an excessive current flows through the light-emitting element L1 included in the pixel circuit 103 determined as a defective pixel. As a result, the light-emitting element L1 included in the pixel circuit 103 determined as a defective pixel may excessively emit light. However, when the pixel circuit 103 is determined as a defective pixel, the correction value calculation unit 113 performs the processing of step S1003 exemplified in FIG. 10 and determines the correction value 123 such that the luminance is made to zero. Accordingly, the compensation unit 115 corrects the input image 124 such that the light-emitting element L1 included in the pixel circuit 103 determined as a defective pixel does not emit light, and generates the corrected image 125.

In step S1103, the display control unit 116 supplies the corrected image 125 to the plurality of pixel circuits 103 to drive the plurality of pixel circuits 103. Accordingly, when the light-emitting element L1 does not emit light at the luminance indicated by the input image 124 due to the change over time or the like, the display control unit 116 increases the luminance of the light-emitting element L1 and does not cause the light-emitting element L1 included in the pixel circuit 103 determined as the defective pixel to emit light. As a result, the display control unit 116 can suppress excessive light emission while controlling the light-emitting elements L1 included in the pixel circuits 103 to emit light at the luminances indicated by the input image 124.

Furthermore, the control device 102 can determine whether or not the pixel circuit 103 is a defective pixel even after starting the use of the display device 100 by performing the processing of determining a defective pixel exemplified in FIG. 8 and FIG. 9 at predetermined time intervals. Therefore, even after starting the use of the display device 100, the control device 102 performs the processing exemplified in FIG. 10 and FIG. 11 to compensate the luminances of the light-emitting elements L1 so as to be increased and to suppress excessive light emission of the light-emitting elements L1. Therefore, the control device 102 can suppress a decrease in display quality due to a change in characteristics of the pixel circuit 103.

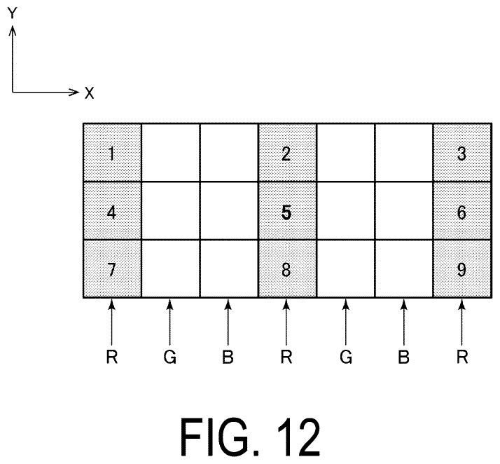

FIG. 12 is a diagram illustrating an example of a pixel structure in which R (red), G (green), and B (blue) are disposed in this order in the X direction. For example, regarding the subpixels of RGB, the pixel number of the pixel circuit 103 to be determined, which is the subpixel of R, is 5. In addition, the pixel numbers of the peripheral pixel circuits, which are the subpixels of R, are 1 to 4 and 6 to 9. Regarding the light-emitting elements L1, it is desirable to refer to the characteristic values 121 between the light-emitting elements L1 that emit light of the same color. This is because the characteristic value of the light-emitting element L1 varies depending on an emission color. Therefore, in the case of the example illustrated in FIG. 12, in the horizontal direction, the characteristic values 121 of the subpixels of the same light emission color at distant positions from each other are referenced to each other. Note that as for the characteristic values 121 of the drive transistors T2, the characteristic values 121 of the drive transistors T2 in the subpixels of different emission colors may be referenced to each other.

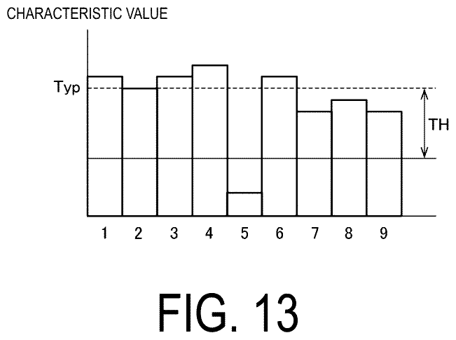

FIG. 13 is a graph illustrating an example of the characteristic values 121 of the pixel circuits 103 of the pixel numbers 1 to 9 exemplified in FIG. 12. The characteristic values 121 illustrated in FIG. 13 are current values. In FIG. 13, the horizontal axis represents a pixel number and the vertical axis represents a characteristic value. In the graph exemplified in FIG. 13, the characteristic value 121 of the pixel circuit 103 having the pixel number 5 is lower than a representative characteristic value Typ of the peripheral pixel circuits having the pixel numbers 1 to 4 and 6 to 9 by a threshold value TH or more. For example, the representative characteristic value Typ is an average value of the characteristic values 121 of the peripheral pixel circuits whose pixel numbers are 1 to 4 and 6 to 9.

When the defective pixel condition is that the characteristic value 121 of the pixel circuit 103 to be determined is lower than the representative characteristic value Typ of the plurality of peripheral pixel circuits by the threshold value TH or more, the defect determination unit 112 determines that the pixel circuit 103 having the pixel number 5 is a defective pixel. In this case, the correction value calculation unit 113 determines the correction value 123 such that the luminance of the light-emitting element L1 included in the pixel circuit 103 having the pixel number 5 is made to zero. Based on the determined correction value 123, the compensation unit 115 corrects the input image 124 such that the luminance of the light-emitting element L1 included in the pixel circuit 103 having the pixel number 5 is made to zero.

As described above, when the characteristic of an element included in the pixel circuit 103 varies due to a change over time and the light-emitting element L1 does not emit light at the luminance designated by the input image 124, the display device 100 according to the present embodiment perform compensation so as to increase the luminance of the light-emitting element L1 based on the characteristic value 121 of the drive transistor T2 or the light-emitting element L1. Furthermore, in the case where the measurement transistor T3 is defective and the elements other than the measurement transistor T3 are normal, the display device 100 according to the present embodiment performs compensation such that a current does not flow through the light-emitting element L1 included in the pixel circuit 103 determined as a defective pixel. As a result, the display device 100 according to the present embodiment can perform compensation such that the luminances of the light-emitting element L1 before and after the change over time are equivalent to each other with respect to the same gray scale value, and can prevent the light-emitting element L1 included in the pixel circuit 103 determined as a defective pixel from excessively emitting light.

Therefore, when the light-emitting element L1 does not emit light at the luminance of the gray scale value designated by the input image 124, the display device 100 according to the present embodiment can compensate the pixel circuit 103 in which the measurement transistor T3 is normal so as to increase the luminance of the light-emitting element L1 while suppressing deterioration in display quality due to the pixel circuit 103 in which the measurement transistor T3 is defective. Furthermore, the control device 100 according to the present embodiment determines a defective pixel at predetermined time intervals and determines a correction value. Thus, when an image is displayed on the display panel 101, the light-emitting element L1 can be prevented from excessively emitting light also in the pixel circuit 103 that is a newly generated defective pixel.

### Second Embodiment

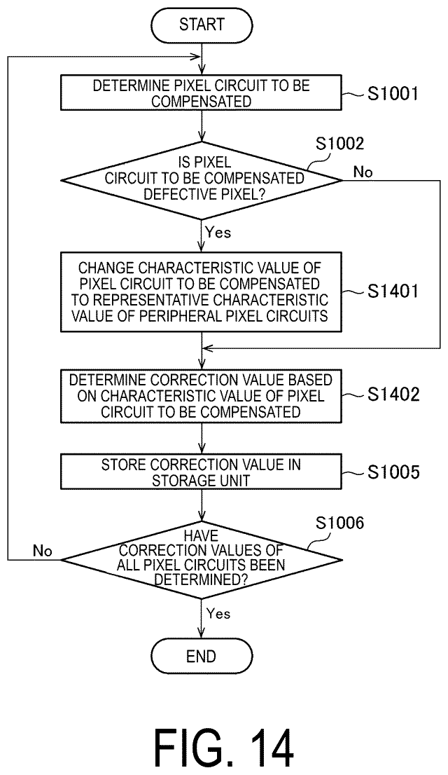

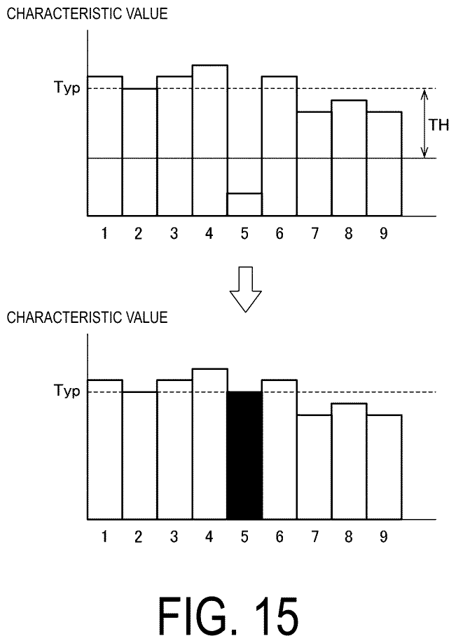

A second embodiment will be described with reference to FIG. 14 to FIG. 15. Note that, in the drawings, identical or equivalent elements are given an identical reference sign, and redundant descriptions thereof may be omitted. The configurations and processing having functions substantially common to those in the first embodiment are denoted by the common reference signs and the descriptions thereof will be omitted. Differences from the first embodiment will be described.

Since the configuration of the display device 100 according to the present embodiment is as exemplified in FIG. 1 to FIG. 3, a detailed description thereof will be omitted.

When the pixel circuit 103 is determined as a defective pixel, the compensation unit 115 according to the present embodiment makes a current flowing through the light-emitting element L1 lower than a current when the pixel circuit 103 is not determined as a defective pixel, according to the characteristic values 121 measured for a plurality of peripheral pixel circuits different from the pixel circuit 103. Specifically, when the pixel circuit 103 is determined as a defective pixel, the compensation unit 115 determines the luminance of the pixel circuit 103 based on the representative characteristic value of the plurality of peripheral pixel circuits and corrects the input image 124 to generate the corrected image 125.

FIG. 14 is a flowchart illustrating an example of processing of determining the correction value 123 in the control device 102 according to the present embodiment. It is assumed that the defect identification information 122 and the characteristic values 121 of the plurality of pixel circuits 103 are stored in the storage unit 114 at the time when processing of step S1001 exemplified in FIG. 14 is started. Processing of steps S1001 to S1002 exemplified in FIG. 14 is similar to that of steps S1001 to S1002 exemplified in FIG. 10, and thus detailed descriptions thereof will be omitted.

When it is not determined in step S1002 that the pixel circuit 103 to be compensated is a defective pixel, the control device 102 shifts the processing to step S1402. On the other hand, when it is determined in step S1002 that the pixel circuit 103 to be compensated is a defective pixel, in step S1401, the correction value calculation unit 113 changes the characteristic value 121 of the pixel circuit 103 to be compensated to the representative characteristic value of the peripheral pixel circuits. That is, when it is determined that the pixel circuit 103 to be compensated is a defective pixel, the correction value calculation unit 113 sets the characteristics of the elements included in the pixel circuit 103 to be equivalent to the characteristics of the elements included in the peripheral pixel circuits in a pseudo manner. Note that when it is determined that the pixel circuit 103 to be compensated is a defective pixel for any one of the subpixels of RGB, the compensation unit 115 may change the characteristic value 121 of each of all the subpixels constituting the pixel including the one subpixel to the representative characteristic value of the peripheral pixel circuits.

In step S1402, the correction value calculation unit 113 determines the correction value 123 based on the characteristic value 121 of the pixel circuit 103 to be compensated. Then, the control device 102 shifts the processing to step S1005. Processing of step S1005 to step S1006 is similar to that of steps S1005 to S1006 exemplified in FIG. 10, and thus detailed descriptions thereof will be omitted.

In a case of a general image, luminances of pixels close to each other tend to have values close to each other. This is because as the distance is closer, the objects displayed in the pixels tend to be more highly related with each other. Further, when various images are displayed for a long period of time, cumulative values of the luminances of the pixels described above become closer to each other. Therefore, it can be considered that the cumulative values of the luminances of pixels having a very short distance therebetween, such as adjacent pixels, are substantially equivalent to each other. A change over time of a pixel is related to a cumulative value of luminances. Therefore, it can be considered that changes over time of pixels close to each other, such as adjacent pixels, are substantially equivalent to each other.

Thus, for example, a change over time in one pixel circuit 103 is substantially equivalent to changes over time in the pixel circuits 103 disposed around the one pixel circuit 103. That is, when the characteristic of the element included in the pixel circuit 103 changes due to the change over time, the characteristic value 121 of one pixel circuit 103 and the characteristic values 121 of the pixel circuits 103 disposed around the one pixel circuit 103 are substantially equivalent to each other. Therefore, when it is determined that the pixel circuit 103 to be compensated is a defective pixel, the correction value calculation unit 113 determines the correction value 123 based on the characteristic values 121 of the peripheral pixel circuits. Then, the compensation unit 115 corrects the input image 124 based on the determined correction value 123. Thus, the control device 102 can cause the light-emitting element L1 included in the pixel circuit 103 determined as a defective pixel to emit light at a luminance equivalent to those of the light-emitting elements L1 included in the peripheral pixel circuits. That is, the control device 102 can cause the light-emitting element L1 included in the pixel circuit 103 determined as a defective pixel not to excessively emit light but to emit light so as to fit to the light-emitting elements L1 included in the peripheral pixel circuits. Accordingly, the control device 102 can suppress deterioration in display quality due to the pixel circuit 103 being a defective pixel.

FIG. 15 illustrates an example of the characteristic value 121 to be corrected for the pixel circuit 103 disposed in the pixel structure exemplified in FIG. 12 in the control device 102 according to the present embodiment. The characteristic value 121 illustrated in FIG. 15 is a current value. In FIG. 15, the horizontal axis represents a pixel number and the vertical axis represents a characteristic value. The graph exemplified in the upper part of FIG. 15 is a graph illustrating an example of the characteristic values 121 of the pixel circuits of the pixel numbers 1 to 9 exemplified in FIG. 12. In the graph exemplified in the upper part of FIG. 15, the characteristic value 121 of the pixel circuit 103 to be determined whose pixel number is 5 is lower than a representative characteristic value Typ of the peripheral pixel circuits whose pixel numbers are 1 to 4 and 6 to 9 by a threshold value TH or more. Thus, the defect determination unit 112 determines that the pixel circuit 103 having the pixel number 5 is a defective pixel.

In a plurality of adjacent pixel circuits 103, the characteristics of the drive transistor T2 and the light-emitting element L1 change over time to substantially the same extent. Therefore, even when the pixel circuit 103 having the pixel number 5 is determined as a defective pixel due to the measurement transistor T3 being defective, the characteristics of the drive transistor T2 and the light-emitting element L1 included in the pixel circuit 103 may be equivalent to the characteristics of the peripheral pixel circuits having the pixel numbers 1 to 4 and 6 to 9.

Because of this, as exemplified in the lower part of FIG. 15, the correction value calculation unit 113 corrects the characteristic value 121 of the pixel circuit 103 whose pixel number is 5 to the representative characteristic value Typ of the peripheral pixel circuits whose pixel numbers are 1 to 4 and 6 to 9. Then, the correction value calculation unit 113 determines the correction value 123 based on the corrected characteristic value 121. Accordingly, the compensation unit 115 compensates the luminance of the light-emitting element L1 included in the pixel circuit 103 having the pixel number 5 to be equivalent to those of the peripheral pixel circuits having the pixel numbers 1 to 4 and 6 to 9.

As described above, the control device 102 according to the present embodiment can cause the light-emitting element L1 included in the pixel circuit 103 being a defective pixel to emit light so as to be fitted to the light-emitting elements L1 included in the peripheral pixel circuits while suppressing a decrease in display quality due to a change in characteristic of the pixel circuit 103.

### MODIFIED EXAMPLE

As a modified example of the control device 102 according to the present embodiment, the correction value calculation unit 113 may correct the characteristic value 121 of the pixel circuit 103 determined as a defective pixel to the representative characteristic value of the plurality of pixel circuits 103. For example, the correction value calculation unit 113 may correct the characteristic value 121 of the pixel circuit 103 determined as a defective pixel to a representative characteristic value of all the pixel circuits 103. The representative characteristic value of all the pixel circuits 103 is a representative value such as an average value of the characteristic values 121 of all the pixel circuits 103.

Alternatively, the correction value calculation unit 113 may thin out and extract a plurality of pixel circuits 103 from all the pixel circuits 103. For example, the correction value calculation unit 113 extracts the pixel circuits 103 at intervals of a predetermined number of pixels in each of the vertical and horizontal directions. The predetermined number of pixels is, for example, five pixels. Then, the correction value calculation unit 113 may correct the characteristic value 121 of the pixel circuit 103 being a defective pixel to a representative characteristic value of the plurality of extracted pixel circuits 103.

The control device 102 according to the present modified example does not need to calculate the characteristic value 121 after correction for each pixel circuit 103 determined as a defective pixel. Thus, the control device 102 according to the present modified example can suppress an amount of calculation for calculating the characteristic value 121 after correction.

Furthermore, the control device 102 according to the present modified example can suppress a decrease in display quality due to the pixel circuit 103 being a defective pixel without causing the light-emitting element L1 included in the pixel circuit 103 being a defective pixel to excessively emit light.

### Third Embodiment

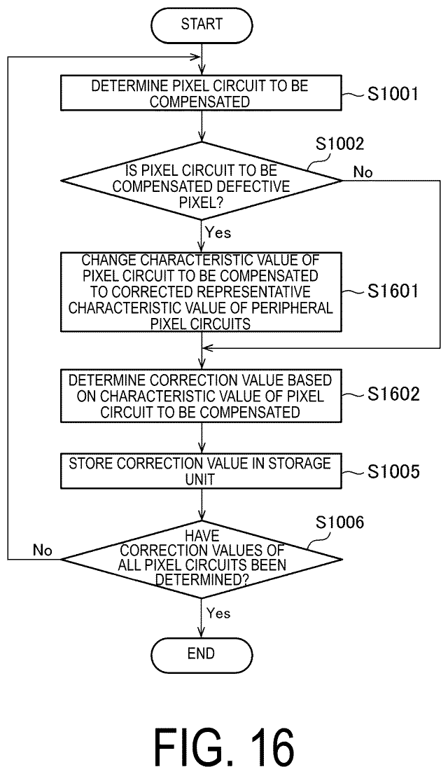

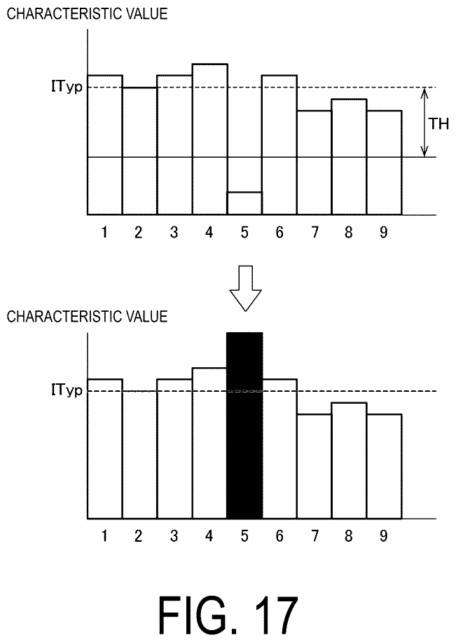

A third embodiment will be described with reference to FIG. 16 to FIG. 17. Note that, in the drawings, identical or equivalent elements are given an identical reference sign, and redundant descriptions thereof may be omitted. The configurations and processing having functions substantially common to those in the first embodiment are denoted by the common reference signs and the descriptions thereof will be omitted. Differences from the first embodiment will be described.

Since the configuration of the display device 100 according to the present embodiment is as exemplified in FIG. 1 to FIG. 3, a detailed description thereof will be omitted.

When the pixel circuit 103 is determined as a defective pixel, the compensation unit 115 according to the present embodiment determines a luminance lower than a luminance determined based on the representative characteristic value of the peripheral pixel circuits and corrects the input image 124 to generate the corrected image 125.

FIG. 16 is a flowchart illustrating an example of processing of determining the correction value 123 in the control device 102 according to the present embodiment. It is assumed that the defect identification information 122 and the characteristic values 121 of the plurality of pixel circuits 103 are stored in the storage unit 114 at the time when the processing of step S1001 exemplified in FIG. 16 is started. Processing of step S1001 to step S1002 exemplified in FIG. 16 is similar to that of step S1001 to step S1002 exemplified in FIG. 10, and thus detailed descriptions thereof will be omitted.

When it is not determined in step S1002 that the pixel circuit 103 to be compensated is a defective pixel, the control device 102 shifts the processing to step S1602. On the other hand, when it is determined in step S1002 that the pixel circuit 103 to be compensated is a defective pixel, in step S1601, the correction value calculation unit 113 corrects the characteristic value 121 of the pixel circuit 103 to be compensated to a value obtained by correcting the representative characteristic value of peripheral pixel circuits.

For example, the correction value calculation unit 113 corrects the characteristic value 121 of the pixel circuit 103 to be compensated to a value obtained by multiplying the representative characteristic value of the peripheral pixel circuits by a predetermined coefficient. Further, for example, when the pixel circuit 103 to be compensated is determined as a defective pixel for any one of the subpixels of RGB, the correction value calculation unit 113 may correct the characteristic value 121 of the pixel circuit 103 to a value obtained by correcting the representative characteristic value of the peripheral pixel circuits for each of all the subpixels constituting the pixel including the one subpixel.

Specifically, when the characteristic value 121 indicates a current value, the correction value calculation unit 113 corrects the characteristic value 121 of the pixel circuit 103 to be compensated to a value higher than the representative current value of the peripheral pixel circuits. That is, when the pixel circuit 103 to be compensated is determined as a defective pixel, the correction value calculation unit 113 sets a current flowing through the light-emitting element L1 included in the pixel circuit 103 determined as the defective pixel to be larger than currents flowing through the light-emitting elements L1 included in the peripheral pixel circuits in a pseudo manner.

On the other hand, when the characteristic value 121 indicates a voltage value, the correction value calculation unit 113 corrects the characteristic value 121 of the pixel circuit 103 to be compensated to a value lower than the representative voltage value of the peripheral pixel circuits. That is, when the pixel circuit 103 to be compensated is determined as a defective pixel, the correction value calculation unit 113 sets a voltage applied to the light-emitting element L1 included in the pixel circuit 103 determined as the defective pixel to be lower than voltages applied to the light-emitting elements L1 included in the peripheral pixel circuits in a pseudo manner.

In step S1602, the correction value calculation unit 113 determines the correction value 123 based on the characteristic value 121 of the pixel circuit 103 to be compensated. Then, the control device 102 shifts the processing to step S1005. Processing of step S1005 to step S1006 is similar to that of steps S1005 to S1006 exemplified in FIG. 10, and thus detailed descriptions thereof will be omitted.

For example, it is assumed that the characteristic value 121 of the pixel circuit 103 to be compensated is lower than the representative current value of the peripheral pixel circuits by a first threshold value or more. In this case, it is assumed that the control device 102 does not perform the processing of step S1601. In this case, when the compensation unit 115 corrects the input image 124 based on the characteristic value 121, the light-emitting element L1 included in the pixel circuit 103 to be compensated may excessively emit light. However, when it is determined that the pixel circuit 103 to be compensated is a defective pixel, the control device 102 according to the present embodiment determines the correction value 123 such that the luminance of the light-emitting element L1 included in the pixel circuit 103 determined as the defective pixel is made lower than the luminances of the light-emitting elements L1 included in the peripheral pixel circuits. Accordingly, the control device 102 can cause the light-emitting element L1 included in the pixel circuit 103 being a defective pixel not to excessively emit light but to emit light more darkly than the light-emitting elements L1 included in the peripheral pixel circuits.

Therefore, the control device 102 according to the present embodiment can suppress deterioration in display quality due to the pixel circuit 103 being a defective pixel. Furthermore, the control device 102 according to the present embodiment causes the light-emitting element L1 included in the pixel circuit 103 being a defective pixel to emit light more darkly than the light-emitting elements L1 included in the peripheral pixel circuits, so that it is possible to cause the pixel circuit 103 being a defective pixel to contribute to display of an image while suppressing a decrease in display quality. In addition, the control device 102 according to the present embodiment can make the defective pixel less noticeable than in a case where the light-emitting element L1 included in the pixel circuit 103 being the defective pixel is not turned on at all.

FIG. 17 illustrates an example of the characteristic value 121 to be corrected regarding the pixel circuits 103 disposed in the pixel structure exemplified in FIG. 12 in the control device 102 according to the present embodiment. The characteristic value 121 illustrated in FIG. 17 is a current value. In FIG. 17, the horizontal axis represents a pixel number and the vertical axis represents a characteristic value. The graph illustrated in the upper part of FIG. 17 is a graph illustrating an example of the characteristic values 121, which are current values, of the pixel circuits 103 having the pixel numbers 1 to 9 exemplified in FIG. 12. In the graph illustrated in the upper part of FIG. 17, the characteristic value 121 of the pixel circuit 103 that is to be determined and that has the pixel number 5 is lower than a representative current value ITyp of the peripheral pixel circuits having the pixel numbers 1 to 4 and 6 to 9 by a threshold value TH or more. Thus, the defect determination unit 112 determines that the pixel circuit 103 having the pixel number 5 is a defective pixel.

In a plurality of adjacent pixel circuits 103, the characteristics of the drive transistor T2 and the light-emitting element L1 change over time to substantially the same extent. Thus, even when the pixel circuit 103 is determined as a defective pixel because the measurement transistor T3 is defective, the characteristics of the drive transistor T2 and the light-emitting element L1 included in the pixel circuit 103 determined as the defective pixel may be in a state equivalent to the characteristics of the peripheral pixel circuits.

Therefore, as exemplified in the lower part of FIG. 17, the correction value calculation unit 113 corrects the characteristic value 121 of the pixel circuit 103 having the pixel number 5, which is determined as a defective pixel, to a value obtained by correcting the representative current value ITyp of the peripheral pixel circuits having the pixel numbers 1 to 4 and 6 to 9. Specifically, the correction value calculation unit 113 corrects the characteristic value 121 of the pixel circuit 103 having the pixel number 5 to a value larger than the representative current value ITyp of the peripheral pixel circuits having the pixel numbers 1 to 4 and 6 to 9. Then, the correction value calculation unit 113 determines the correction value 123 based on the corrected characteristic value 121. The compensation unit 115 corrects the input image 124 based on the correction values 123 such that the luminance of the light-emitting element L1 included in the pixel circuit 103 having the pixel number 5 is made lower than the luminances of the light-emitting elements L1 included in the peripheral pixel circuits having the pixel numbers 1 to 4 and 6 to 9.

As described above, the control device 102 according to the present embodiment can cause the pixel circuit 103 being a defective pixel to contribute to display of an image by causing the light-emitting element L1 included in the pixel circuit 103 being the defective pixel to emit rather dark light while suppressing deterioration in display quality due to a change in characteristics of the pixel circuit 103. In addition, the control device 102 according to the present embodiment can make the defective pixel less noticeable than in a case where the light-emitting element L1 included in the pixel circuit 103 being the defective pixel is not turned on at all.

### Fourth Embodiment

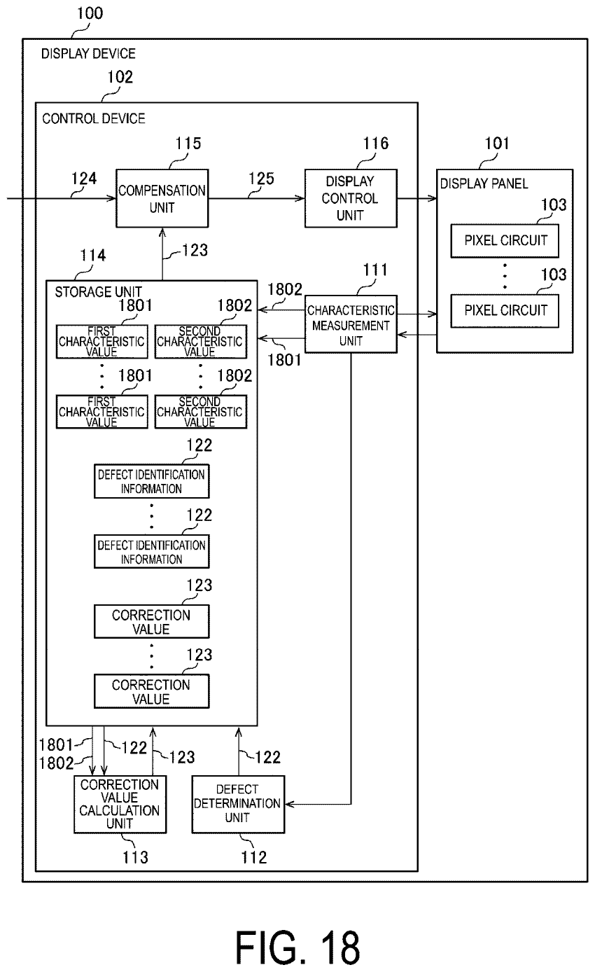

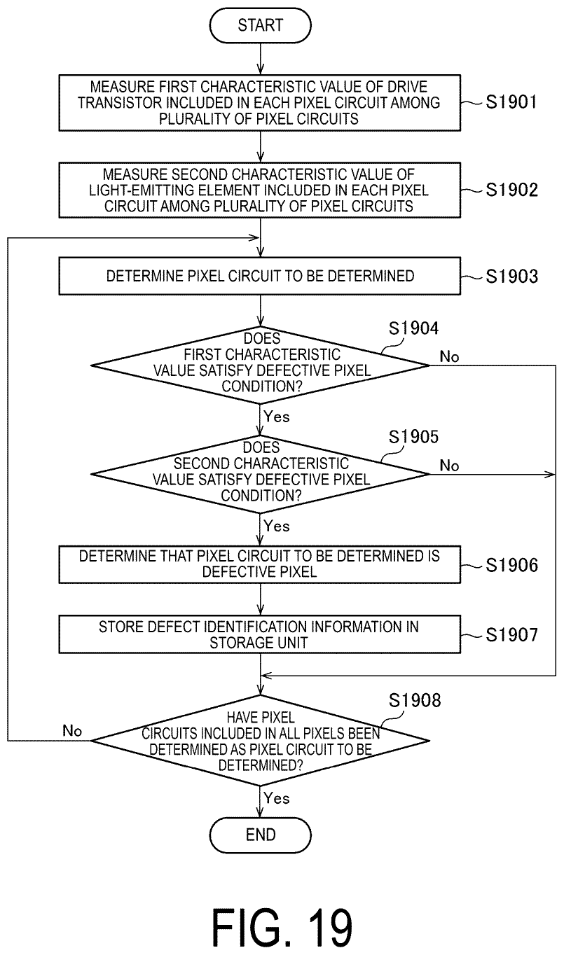

A fourth embodiment will be described with reference to FIG. 18 to FIG. 19. Note that, in the drawings, identical or equivalent elements are given an identical reference sign, and redundant descriptions thereof may be omitted. The configurations and processing having functions substantially common to those in the first embodiment are denoted by the common reference signs and the descriptions thereof will be omitted. Differences from the first embodiment will be described.

FIG. 18 is a block diagram illustrating an example of a configuration of a display device 100 according to the present embodiment. The display device 100 exemplified in FIG. 18 is different from the display device 100 exemplified in FIG. 1 in that the display device 100 exemplified in FIG. 18 stores first characteristic values 1801 and second characteristic value 1802, instead of the characteristic values 121, in the storage unit 114.

The characteristic measurement unit 111 according to the present embodiment measures the first characteristic value 1801 indicating a characteristic of the light-emitting element L1 and the second characteristic value 1802 indicating a characteristic of a drive transistor.

When the first characteristic value 1801 satisfies the defective pixel condition and the second characteristic value 1802 satisfies the defective pixel condition, the defect determination unit 112 according to the present embodiment determines that the pixel circuit 103 is a defective pixel.

The compensation unit 115 according to the present embodiment generates the corrected image 125 by correcting the input image 124 indicating the luminance of each pixel circuit 103 based on at least one selected from the group consisting of the first characteristic value 1801 and the second characteristic value 1802.

FIG. 19 is a flowchart illustrating an example of processing of determining a defective pixel by measuring the characteristic values 121 of the drive transistor T2 and the light-emitting element L1 in the control device 102 according to the present embodiment.

In step S1901, the defect determination unit 112 measures the first characteristic value 1801 of the drive transistor T2 included in each pixel circuit 103. Processing of step S1901 is similar to that of step S801 to step S803 exemplified in FIG. 8, and thus a detailed description thereof will be omitted.

In step S1902, the defect determination unit 112 measures the second characteristic value 1802 of the light-emitting element L1 included in each pixel circuit 103. Processing of step S1902 is similar to that of step S901 to step S903 exemplified in FIG. 9, and thus a detailed description thereof will be omitted.

In step S1903, the defect determination unit 112 determines the pixel circuit 103 to be determined. In step S1904, the defect determination unit 112 determines whether or not the first characteristic value 1801 satisfies the defective pixel condition. To be specific, the defect determination unit 112 determines whether or not the first characteristic value 1801 satisfies the defective pixel condition by performing processing similar to that of step S805 to step S807 exemplified in FIG. 8.

In step S1904, when the first characteristic value 1801 does not satisfy the defective pixel condition, the control device 102 shifts the processing to step S1908. On the other hand, when the first characteristic value 1801 satisfies the defective pixel condition in step S1904, the control device 102 shifts the processing to step S1905.

In step S1905, the defect determination unit 112 determines whether or not the second characteristic value 1802 of the pixel circuit 103 to be determined satisfies the defective pixel condition. To be specific, the defect determination unit 112 determines whether or not the second characteristic value 1802 satisfies the defective pixel condition by performing processing similar to that of steps S905 to S907 exemplified in FIG. 9.

In step S1905, when the second characteristic value 1802 does not satisfy the defective pixel condition, the control device 102 shifts the processing to step S1908. On the other hand, when the second characteristic value 1802 satisfies the defective pixel condition in step S1905, the control device 102 shifts the processing to step S1906.

In step S1906, the defect determination unit 112 determines that the pixel circuit 103 to be determined is a defective pixel. That is, when the first characteristic value 1801 and the second characteristic value 1802 satisfy the defective pixel conditions, the defect determination unit 112 determines that the pixel circuit 103 to be determined is a defective pixel. Then, in step S1907, the defect determination unit 112 stores the defect identification information 122 indicating the pixel number of the pixel circuit 103 to be determined in the storage unit 114.

In step S1908, the defect determination unit 112 determines whether or not the pixel circuits 103 belonging to all the pixels have been determined as the pixel circuit 103 to be determined. In step S1908, when the pixel circuits 103 belonging to all the pixels are not determined as the pixel circuit 103 to be determined, the control device 102 returns the processing to step S1903. That is, the control device 102 repeats the processing from step S1903 to step S1908 until the pixel circuits 103 belonging to all the pixels have been determined as the pixel circuit 103 to be determined. On the other hand, when the pixel circuits 103 belonging to all the pixels are determined as the pixel circuit 103 to be determined in step S1908, the control device 102 ends the processing of determining a defective pixel.

When the measurement transistor T3 is defective, its influence appears in both the characteristic value of the drive transistor T2 and the characteristic value of the light-emitting element L1. Accordingly, when both the first characteristic value 1801 of the drive transistor T2 included in the pixel circuit 103 and the second characteristic value 1802 of the light-emitting element L1 satisfy the defective pixel conditions, the control device 102 according to the present embodiment determines that the pixel circuit 103 is a defective pixel. That is, the control device 102 according to the present embodiment determines whether or not the pixel circuit 103 is a defective pixel based on the characteristic of the drive transistor T2 and the characteristic of the light-emitting element L1. Thus, the control device 102 according to the present embodiment can further determine whether or not the pixel circuit 103 is a defective pixel. As a result, the control device 102 according to the present embodiment can more reliably suppress excessive light emission of the light-emitting element L1 in the pixel circuit 103 in which the measurement transistor T3 is defective while compensating for the luminance of the light-emitting element L1 included in the pixel circuit 103.

As described above, the control device 102 according to the present embodiment can more reliably suppress excessive light emission of the light-emitting element L1 in the pixel circuit 103 in which the measurement transistor T3 is defective while suppressing deterioration in display quality due to a change in the characteristics of the pixel circuit 103.

The disclosure is not limited to each of the embodiments described above, and various modifications may be made within the scope of the claims. Embodiments obtained by appropriately combining technical approaches disclosed in each of the different embodiments also fall within the technical scope of the disclosure. Moreover, novel technical features may be formed by combining the technical approaches disclosed in each of the embodiments.

1. A control device comprising:
a characteristic measurement unit configured, for a pixel circuit including a light-emitting element, a drive transistor configured to control a current flowing through the light-emitting element, and a measurement transistor, to control the measurement transistor and to measure a characteristic value indicating a characteristic of at least one element selected from the group consisting of the light-emitting element and the drive transistor;
a defect determination unit configured to determine that the pixel circuit is a defective pixel when the characteristic value satisfies a defective pixel condition; and
a compensation unit configured to reduce a current flowing through the light-emitting element when the pixel circuit is determined as the defective pixel compared to a current flowing through the light-emitting element when the pixel circuit is not determined as the defective pixel.

2. The control device according to claim 1,
wherein the compensation unit does not cause a current to flow to the light-emitting element when the pixel circuit is determined as the defective pixel.

3. The control device according to claim
wherein the pixel circuit is included in a plurality of pixel circuits,
the compensation unit corrects, based on a characteristic value measured for each pixel circuit among the plurality of pixel circuits, an input image indicating a luminance of each pixel circuit and generates a corrected image, and
the control device further includes a display control unit configured to supply voltages corresponding to the corrected image to the plurality of pixel circuits and to drive the plurality of pixel circuits.

4. The control device according to claim 3,
wherein when the pixel circuit is determined as the defective pixel, the compensation unit reduces the current flowing through the light-emitting element, compared to the current flowing through the light-emitting element when the pixel circuit is not determined as the defective pixel, according to a plurality of characteristic values measured for a plurality of peripheral pixel circuits different from the pixel circuit.

5. The control device according to claim 4,
wherein when the pixel circuit is determined as the defective pixel, the compensation unit determines the luminance of the pixel circuit based on a representative characteristic value of the plurality of characteristic values individually measured for the plurality of peripheral pixel circuits and corrects the input image, and thus generates the corrected image.

6. The control device according to claim 5,
wherein when the pixel circuit is determined as the defective pixel, the compensation unit determines the luminance of the pixel circuit lower than the luminance determined based on the representative characteristic value and corrects the input image, and thus generates the corrected image.

7. The control device according to claim 4,
wherein each peripheral pixel circuit among the plurality of peripheral pixel circuits is disposed at a position adjacent to the pixel circuit.

8. The control device according to claim 5,
wherein the characteristic value indicates a current value of a current flowing through the at least one element when a voltage of a predetermined voltage value is applied to the at least one element,
the representative characteristic value is a representative current value of a plurality of current values individually measured for the plurality of peripheral pixel circuits, and
the defective pixel condition is that the current value is lower than the representative current value by a first threshold value or more.

9. The control device according to claim 5,
wherein the characteristic value indicates a voltage value of a voltage applied to the at least one element when a current having a predetermined current value flows through the at least one element,
the representative characteristic value is a representative voltage value of a plurality of voltage values individually measured for the plurality of peripheral pixel circuits, and
the defective pixel condition is that the voltage value is higher than the representative voltage value by a second threshold value or more.

10. The control device according to claim 4,
wherein a plurality of the light-emitting elements individually provided in the plurality of pixel circuits include two or more types of light-emitting elements configured to emit light of colors different from each other, and
the light-emitting element included in each pixel circuit and a plurality of the light-emitting elements individually included in the plurality of peripheral pixel circuits emit light of the same color.

11. The control device according to claim 1,
wherein the characteristic measurement unit measures a first characteristic value indicating a characteristic of the light-emitting element and a second characteristic value indicating a characteristic of the drive transistor, and
the defect determination unit determines that the pixel circuit is the defective pixel when the first characteristic value satisfies the defective pixel condition and the second characteristic value satisfies the defective pixel condition.

12. A display device comprising:
a plurality of the pixel circuits; and
the control device according to claim 1.

13. A control device comprising:
a characteristic measurement unit configured, for a pixel circuit including a light-emitting element, a drive transistor configured to control a current flowing through the light-emitting element, and a measurement transistor, to control the measurement transistor and to measure a characteristic value indicating a characteristic of at least one element selected from the group consisting of the light-emitting element and the drive transistor; and
a compensation unit configured to reduce a current flowing through the light-emitting element in a case where a current value of a current flowing through the at least one element is equal to or smaller than a predetermined current value when the characteristic measurement unit applies a voltage having a predetermined voltage value to the at least one element.

14. A control device comprising:
a characteristic measurement unit configured, for a pixel circuit including a light-emitting element, a drive transistor configured to control a current flowing through the light-emitting element, and a measurement transistor, to control the measurement transistor and to measure a characteristic value indicating a characteristic of at least one element selected from the group consisting of the light-emitting element and the drive transistor; and
a compensation unit configured to reduce a current flowing through the light-emitting element when a voltage value of a voltage required for causing a current having a predetermined current value to flow through the at least one element by the characteristic measurement unit is equal to or larger than a predetermined voltage value.
